(19) United States
(12) Patent Application Publication
(10) Pub. No.: US 2019/0274422 A1
(43) Pub. Date: Sep. 12, 2019

(54) EXPANDABLE SPICE RACK

(71) Applicant: Discovery Inc., Ross, CA (US)

(72) Inventors: Mark W. Levie, Corte Madera, CA (US); David M. Lee, Westminster, CA (US)

(21) Appl. No.: 16/299,106

(22) Filed: Mar. 11, 2019

Related U.S. Application Data
(60) Provisional application No. 62/641,258, filed on Mar. 9, 2018.

(51) Int. Cl. A47B 45/00; A47J 47/16

(52) U.S. Cl. CPC A47B 45/00; A47J 47/16

(57) ABSTRACT

A storage shelving system having a width and a height includes a left lower part, a right lower part, a left upper part, and right upper part. The left lower part is telescopically positioned relative to the right lower part to slide within the left lower part. The left upper part is telescopically positioned relative to the right upper part to slide within the right upper part. The left lower part and left upper part are fixably coupled together such that the left lower part vertically aligns with the left upper part. The right lower part and right upper part are fixably coupled together such that the right lower part vertically aligns with the right upper part. The left lower part and left upper part are movable in concert towards and away from the right lower part and right upper part to increase the width of the shelving system or decrease the width of the shelving system.

### CROSS-REFERENCE TO RELATED APPLICATION

This application claims priority to U.S. Provisional Patent Application No. 62/641,258, filed on Mar. 9, 2018, the disclosure of which is incorporated herein by reference in its entirety.

### FIELD

The present invention concerns storage solutions that are expandable in one or more directions.

### BACKGROUND

Soda can storage containers can be placed in refrigerators and stocked with soda cans so that the cans are readily accessible in the refrigerator while being organized into a small space. Can storage containers or racks can be placed on pantry shelves or in kitchen cabinets for organizing and storing cans of any type. One type of can storage device permits the cans to be placed on their sides so that when one can is removed, the remaining cans in the rack fill the vacated space by force of gravity. These racks include side and rear walls, as well as a lip or partial front wall to retain the cans in the interior of the rack.

Spice racks are known for organizing and positioning spices in a cabinet. Types of spice racks include wire or plastic racks that have steps so that spices in the rear can be seen over spices that are positioned in the front. Stationary spice racks are also known that can be fixed to a wall. Other spice racks are known.

Storage solutions that improve the organization of kitchen cabinets and refrigerators are beneficial to promote an organized home.

### BRIEF DESCRIPTION OF THE DRAWINGS

FIG. 1 is a perspective view of an expandable spice rack according to the invention, shown in a fully expanded position, and showing spice jars positioned on the storage unit;

FIG. 2 is a front view of the embodiment shown in FIG. 1;

FIG. 3 is a front perspective view of the storage unit of FIGS. 1-2 in a partially expanded position;

FIG. 4 is a bottom perspective view of the storage unit shown in FIG. 3;

FIG. 5 is a top perspective view of the storage unit shown in FIG. 3;

FIG. 6 is a side perspective view of the storage unit shown in FIG. 3;

FIG. 7 is a top perspective view of the storage unit of FIGS. 40-41 in a first vertically expanded position;

FIG. 8 is a front perspective view of the storage unit of FIGS. 1-2 shown in a fully vertically and horizontally expanded position;

FIG. 9 is a top perspective view of the storage unit shown in FIG. 8;

FIG. 10 is a side perspective view of the storage unit shown in FIG. 8;

FIG. 11 is a top view of the storage unit shown in FIG. 8;

FIG. 12 is a perspective view showing interior surfaces of the storage unit shown in FIG. 8;

FIG. 13 is an alternative side perspective view of the storage unit shown in FIG. 8;

FIG. 14 is an alternative perspective view showing interior surfaces of the storage unit shown in FIG. 8;

FIG. 15 is a front perspective view of the storage unit of FIGS. 1-2 in a partially expanded position with a storage shelf installed inside the storage unit;

FIG. 16 is an alternative perspective view of the storage unit and shelf shown in FIG. 15;

FIG. 17 is an alternative interior perspective view of the storage unit and shelf shown in FIG. 15;

FIG. 18 is a front view of another embodiment of the expandable storage unit according to the invention in a fully expanded configuration;

FIG. 19 is a top view of the embodiment of the expandable storage unit of FIG. 18;

FIG. 20 is a side view of the embodiment of the expandable storage unit of FIGS. 18-19;

FIG. 21 is a front view of the embodiment of FIGS. 18-20 in the non-expanded configuration;

FIG. 22 is a top view of the embodiment of the expandable storage unit of FIG. 21; and

FIG. 23 is a side view of the embodiment of the expandable storage unit of FIGS. 21-22.

### SUMMARY

An expandable spice rack is shown and described.

### DETAILED DESCRIPTION

Expandable storage solutions are described herein. One type of storage unit is a spice rack 10. The spice rack 10 of the present invention is designed to be expandable in multiple directions. For example, the spice rack 10 can be expanded in both a horizontal and vertical direction, e.g., in an X and a Y direction. The storage unit 10 described herein includes multiple parts that slide relative to one another. Any type of sliding mechanism may be used. The examples shown herein include a series of slots 26 and pins 24, and tongue and groove.

The storage units 10 shown in the figures include four parts that are movable relative to one another from a non-extended position to a fully extended position. A total of four different positions are available to provide for flexibility in the final shape of the storage unit 10. This permits the user to initially fill the rack in the fully extended position and, then, as the user uses the goods stored in the storage unit 10, the storage unit 10 can be made smaller as the necessary space in the interior of the storage unit 10 is decreased.

The storage units 10 described herein are also beneficial in that they can be changed to fit the space in which a user wants to position them. In this example, a user may transform the shape extending or closing the extended positions. The spice rack 10 is extendable to either add another layer of storage, or to permit taller products 22 to be positioned inside the spice rack 10.

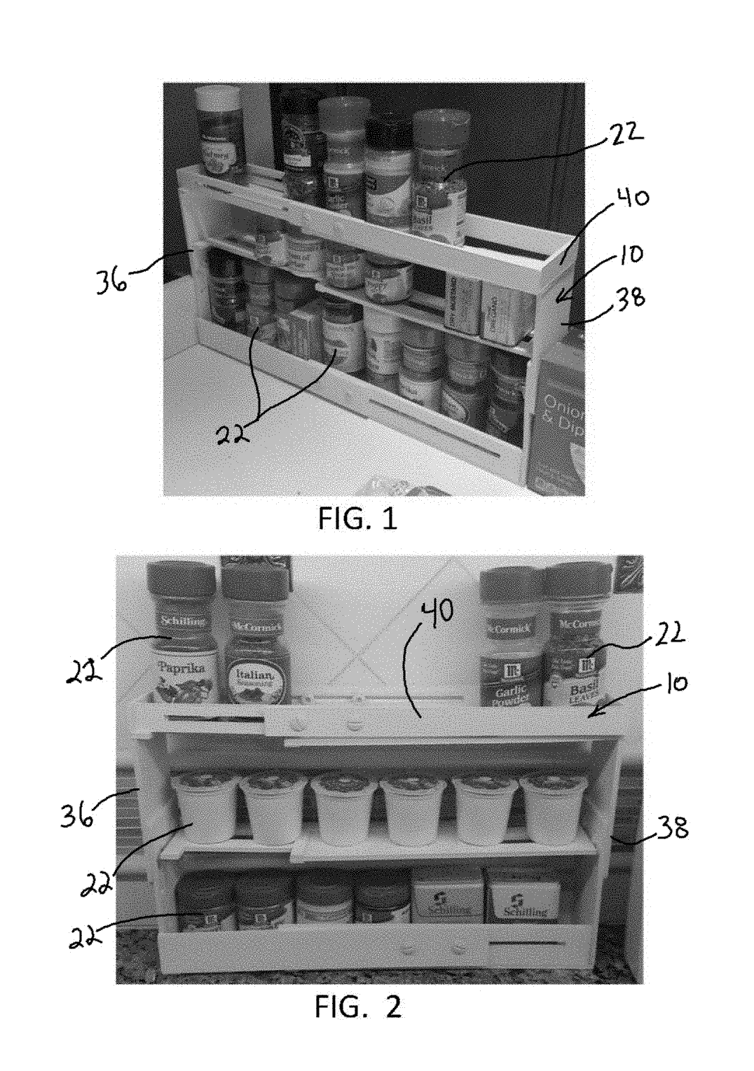

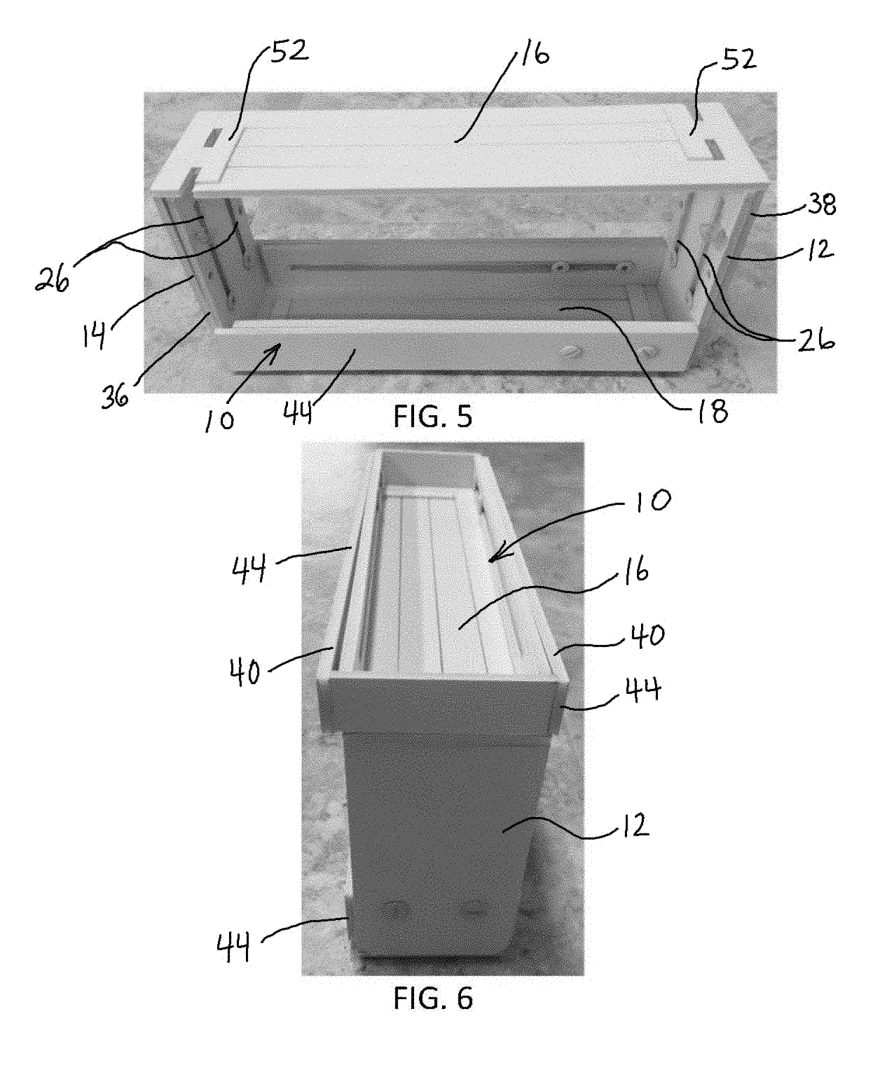

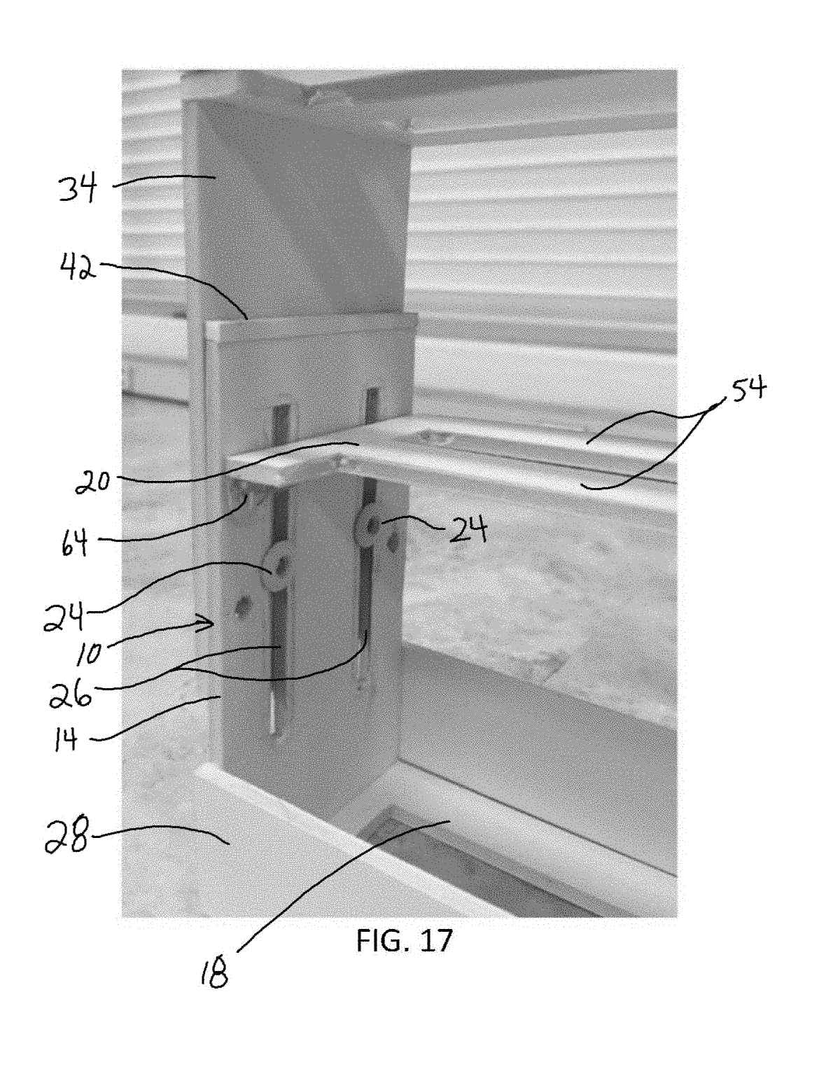

FIGS. 1-23 depict the spice rack 10 according to the invention. The spice rack 10 is extendable up and to the side so that the spice rack 10 has four different configurations. FIGS. 1-2 depict the spice rack 10 outer walls in a fully extended position both upwardly and to the side. The spice rack 10 includes a right-side outer wall 12 and a left side outer wall 14, a top shelf 16, a bottom shelf 18, and an optional middle shelf 20. The spice rack 10 is shown having different products 22 installed on the shelves. The spice rack 10 includes four parts that are coupled together with sliders, which are sliding pins 24, and recesses/slots 26. The four parts include a lower left part 28, a lower right part 30, an upper right part 32, and an upper left part 34. The spice rack 10 is designed to be positioned so that the side walls 12, 14 are positioned at the left and right sides 36, 38, respectively.

FIG. 1 shows the device 10 in a fully extended position to the side and a fully extended position upwardly. FIG. 2 is partially extended to the side and fully extended upwardly, which is evident based on the position of the pins 24 in the respective slots 26.

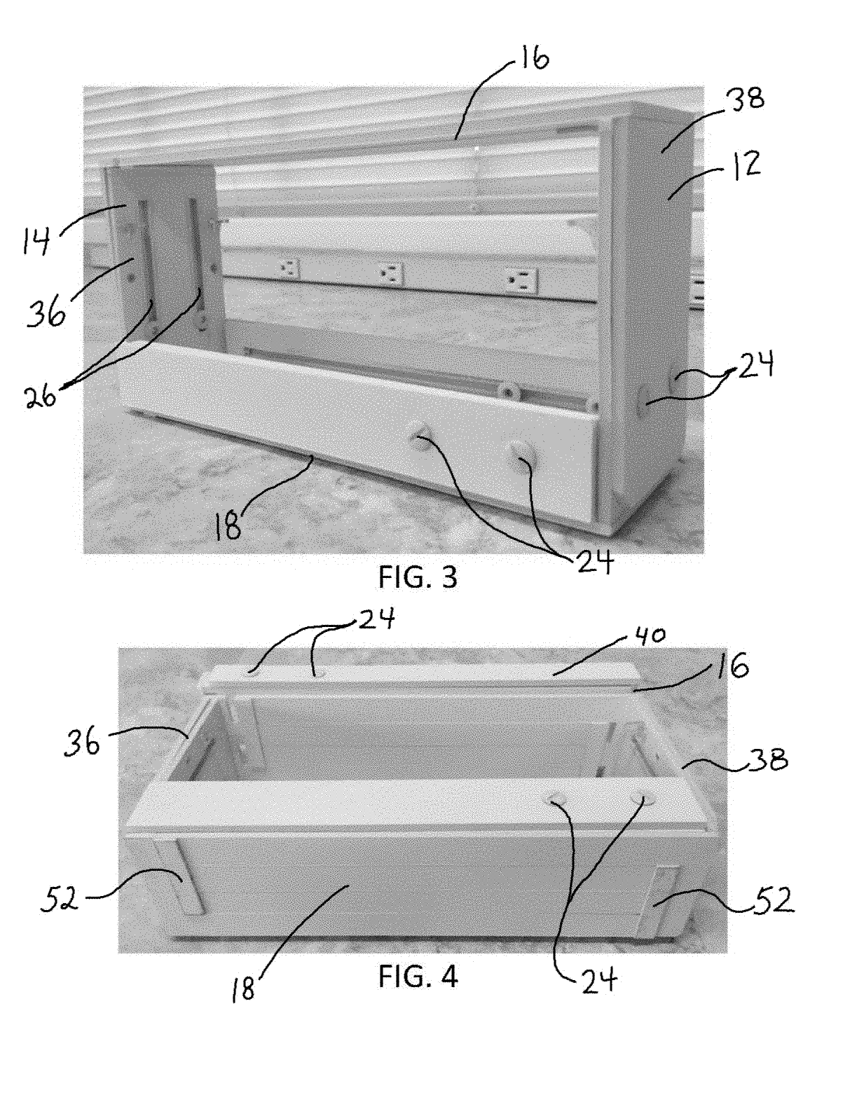

FIGS. 3-6 depict an unexpanded configuration of the spice rack 10. As shown, the lower parts 28, 30 are recessed into the upper parts 32, 34 such that the upper parts 32, 34 form the outer side walls. In addition, the right parts 30, 32 are recessed into the left parts 28, 34 at the lower, right side. The left parts 28, 34 are recessed into the right parts 30, 32 at the upper left side 36. The parts 28, 30, 32, 34 fit together so that when they are pressed inwardly, they fit inside of each other. FIG. 6 depicts an upper wall 16 that has a rim 40 around the upper end for assisting in holding products 22 on the shelf created by the upper wall 16.

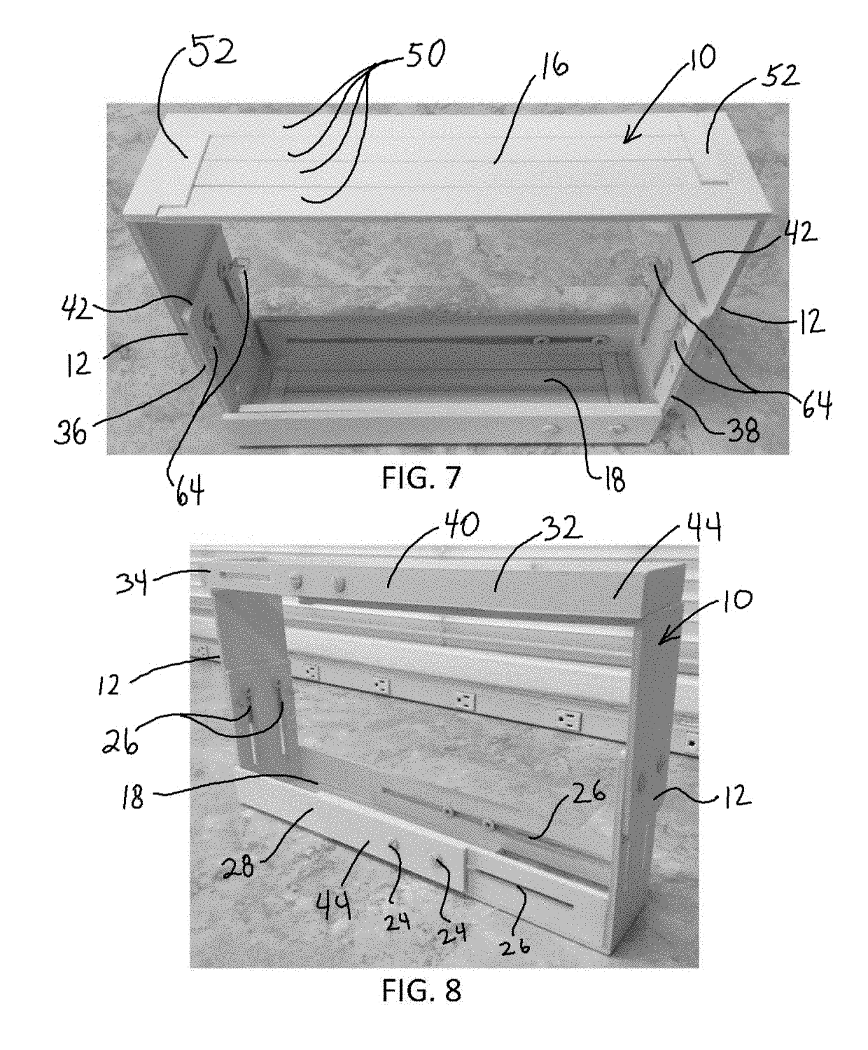

FIG. 7 depicts the spice rack 10 in a partially extended position where the upper parts 32, 34 are extended upwardly, but the right parts 30, 32 are recessed into the left parts 28, 34. In this embodiment, due to the lip 42 created by the top end of the lower side walls, a shelf 20 could be positioned on the lip 42 to span from the left to the right side of the device 10.

FIG. 8 depicts the spice rack 10 in a fully extended position where the upper parts 32, 34 are extended out of the lower parts 28, 30 and the right 30, 32/left parts 28, 34 are extended out of the left 28, 34/right parts 30, 32. As is evident, the right lower part 30 has recesses or slots 26 that are positioned horizontally on the front and rear walls of the right lower part 30. The recesses 26 mate with pins 24 that are positioned on the lower left part 28 and the pins 24 seat in the recesses 26 and ride the recesses 26 as the right lower part 30 is slid out of the left lower part 28. The pins 24 on the left lower part 28 extend inwardly from the front wall and rear wall of the left lower part 28. The pins 24 may be prefabricated and molded with the part, or can be formed by screws or other fasteners that are inserted through the front and rear surfaces. The top left part 34 includes slots 26 that are horizontal, similar to the slots 26 in the lower right part 30. The slots 26 are positioned on both the front and rear sides of the top left part 34. Pins 24 extend inwardly from the front and rear sides of the top right part 32 through the slots 26 and are maintained in the slots 26 in any known manner.

FIG. 8 also shows that the front and rear walls of the lower parts 28, 30 include recesses/slots 26 formed through the front and rear walls. Pins 24 extend inwardly from the front and rear walls of the adjacent upper parts 32, 34. Pins 24 are secured in the slots 26, but are movable in the slots 26. In addition, the front and rear 44 walls of the upper and lower parts 28, 30 form short walls around the bottom surface of the spice rack 10 and the top wall of the spice rack 10. The pins 24 may be tightened when the device 10 is placed into a desired configuration so that the device 10 maintains its shape. Alternatively, the sliders may be configured to hold a desired position without requiring tightening.

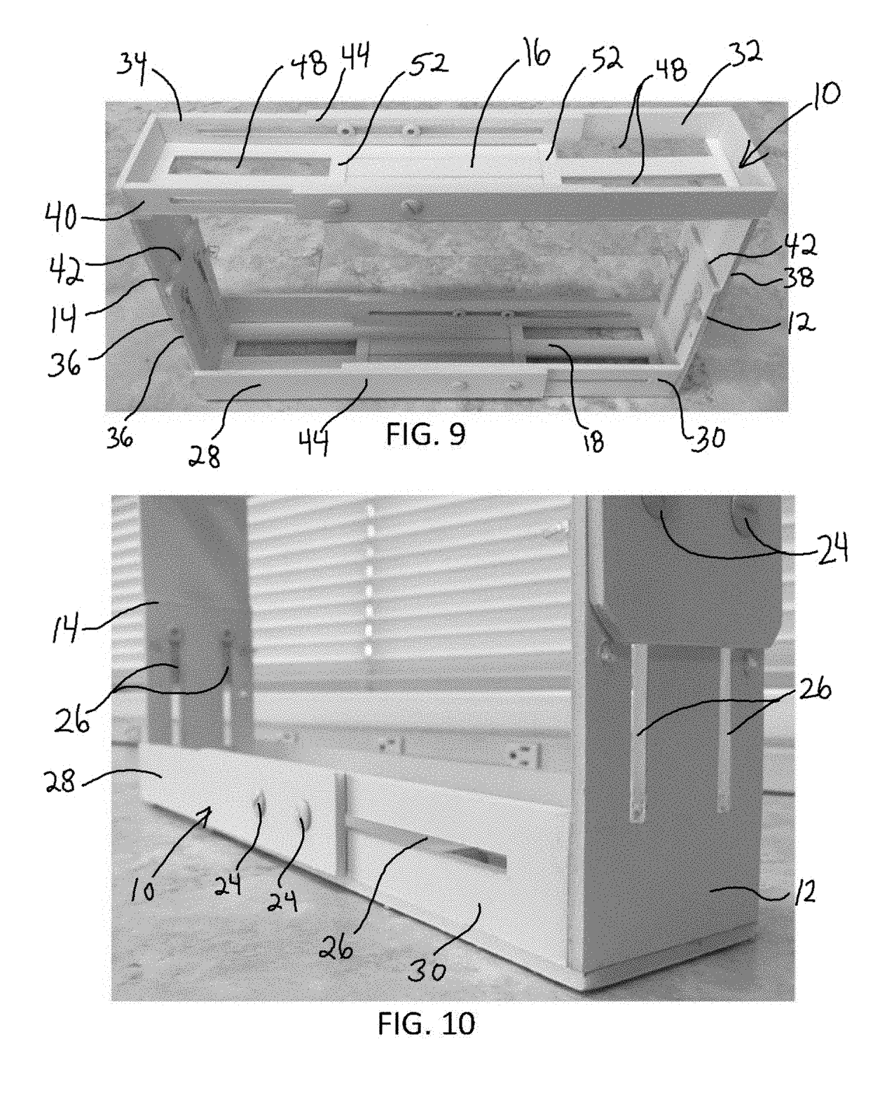

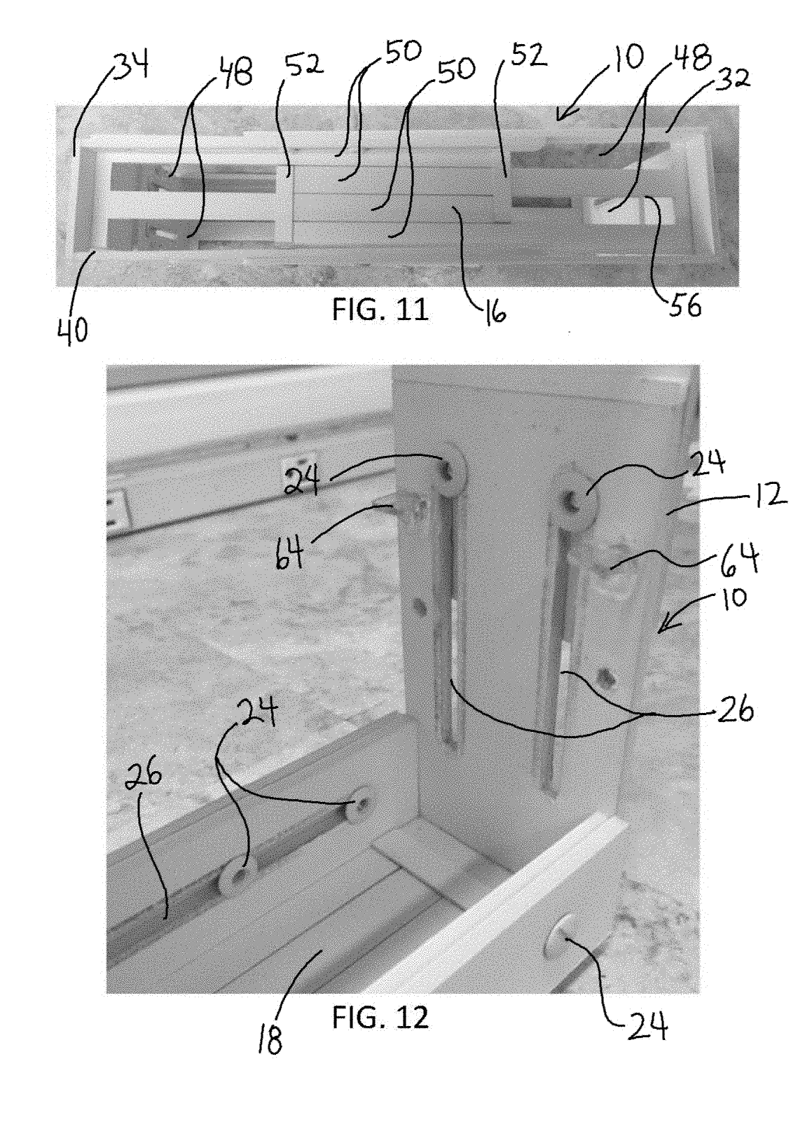

FIG. 9 depicts the spice rack 10 in a fully extended position. As is evident, when in this position, the top and bottom walls 16, 18 include recesses 48 that open when the left 28, 34 and right 30, 32 side parts are pulled away from one another. The top and bottom surfaces/walls 16, 18, however, are still usable as storage surfaces in this position because typically sized spice jars would not be able to fall through the recesses 48. A close-up view of the top wall 16 is shown in FIG. 11. When the left 28, 34 and right parts 30, 32 are pushed together so that the right side 38 is stowed in the left side 36, the recesses 48 in the top and bottom walls 16, 18 are closed by the interaction of the left 28, 34 and right parts 30, 32 with one another.

FIGS. 7 and 11 depict the upper wall 16 of the spice rack 10 in a closed and open position, respectively. FIGS. 22 and 19 depict similar views. The upper wall 16 of the spice rack 10 is substantially the same as the lower wall 18 in terms of function and design. The upper wall 16 is made of two parts that slide relative to each other. Part of the upper wall is coupled to the left side wall 14 and part of the upper surface is coupled to the right-side wall 12. As shown, the upper wall 16 comprises several elongated beams 50 that slide relative to one another. The beams 50 are coupled together at their ends by a cross-beam 52 and the cross-beams 52 serve as stops that deter the left 28, 34 and right 30, 32 sides of the device 10 from splitting apart. The cross beams 52 are shown in a closed position in FIGS. 7 and 22 and in an open position in FIGS. 11 and 19. FIG. 11 shows the beams 50 in partially open position and FIG. 19 shows the beams 50 in a fully open position, where the beams are 50 fully extended to create the widest width for the device 10.

As shown in FIGS. 7 and 22, when the device 10 is in a closed position, the beams 50 work together to create a closed surface (e.g., no openings). When the device 10 is in an open position, as shown in FIGS. 11 and 19, the beams 50 move along their length relative to the other beams 50 to provide openings 48 in the respective wall 16, 18. The beams 50 have a similar width to one another, but other and different widths could be used.

The beams 50 may include side channels/grooves 54 and tongues 56 for seating inside each other. This tongue 56 and groove 54 design permits the beams 50 to slide within each other, further deterring the separation of the beams 50 from one another. Any type of tongue 56 and groove 54 design could be used. The cross-beams may be positioned over the other part's beams, the other part's beams, or both. The cross-beams 52 help to keep the beams 50 in spaced relation and also serve as stops to prevent the left and right sides 36, 38 from separating from one another. Tongue and groove need not be provided. The cross-beams 52 may alone keep the beams of the left and right sides aligned with one another to make the top and bottom walls and the middle shelf 20.

FIGS. 11 and 19 show how the left side 36 has two beams 50, with one being centrally disposed and the other being along a front or rear surface. The right side 38 two beams 50 for mating with the beams 50 of the left side 36. The beams 50 on the right side 38 include one beam 50 that is positioned adjacent the rim and one beam 50 that is positioned in a more central, but not centered, position. Other locations for the beams 50 could be provided, as well as different numbers of beams 50 depending upon the size of the storage device 10 and other factors. When the left and right sides 36, 38 are at their fully open position, the beams 10 cantilever off one another at the cross-beams 52. Although shown, the beams 50 are not required to have tongue and groove construction.

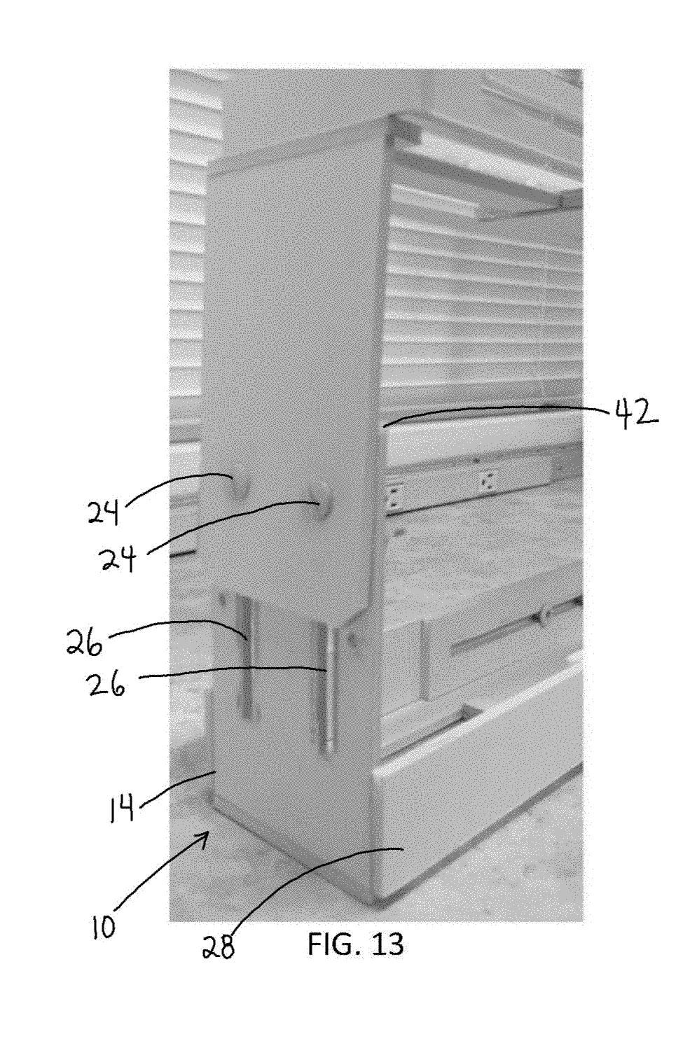

FIGS. 10 and 13 depict a close-up view of the recesses 26 and pins 24 of the spice rack 10.

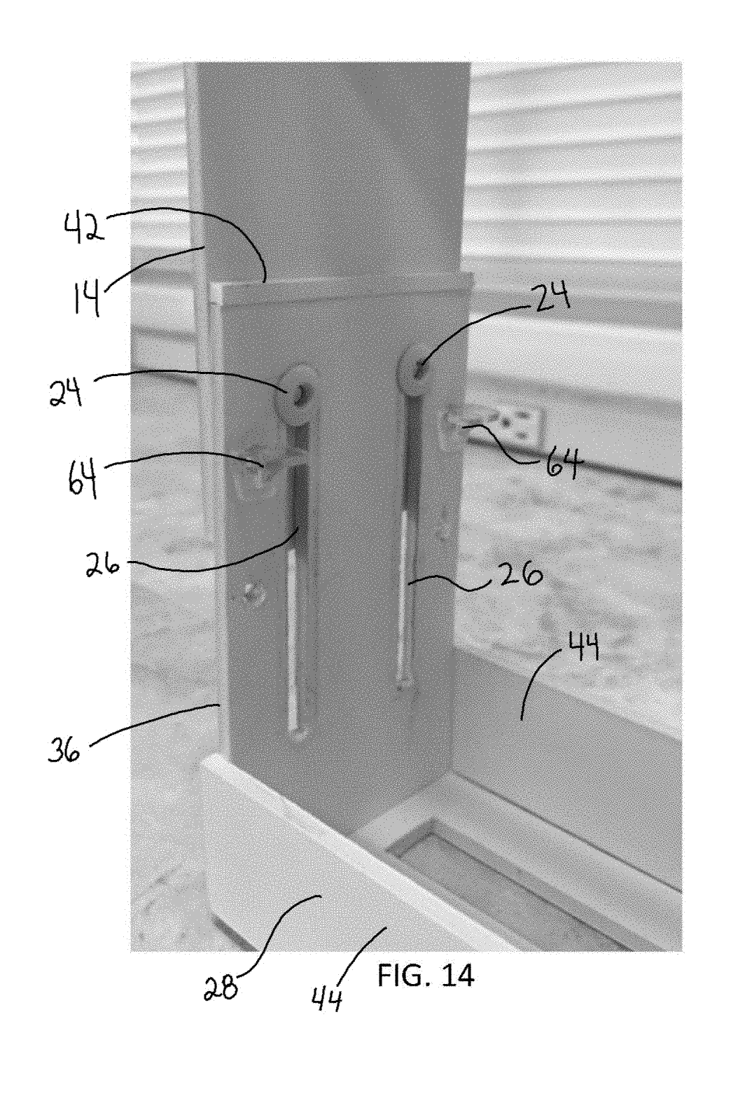

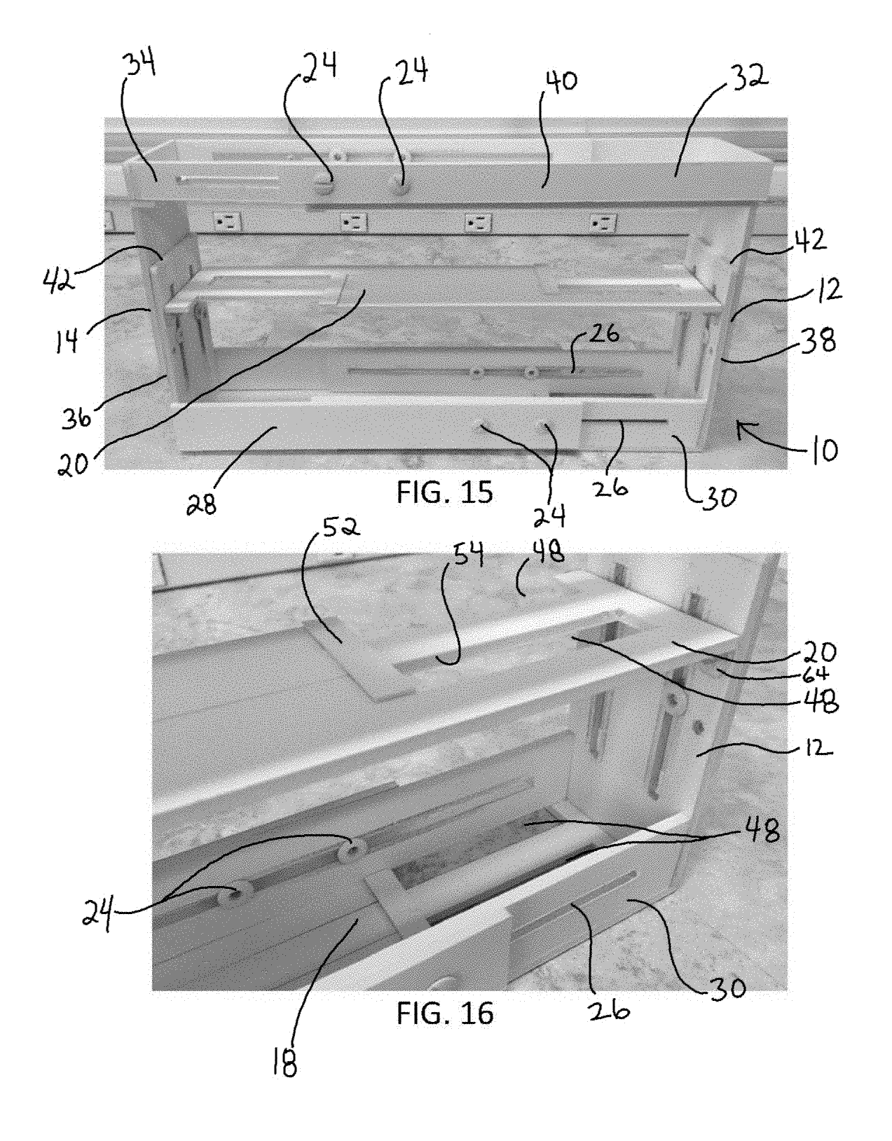

As shown in FIGS. 12 and 14, the inner walls of the left and right sides include ledges 64 that may be added to or removed from the inner walls, or may be integrally molded into the inner walls. Four ledges 64 are shown, including two on each of the left and right inner walls 12, 14. The ledges 64 are configured for supporting a middle shelf 20, which may be provided separately. The middle shelf 20 is shown in FIGS. 15-17 installed on the ledges 64 with the spice rack 10 in the fully expanded position. The middle shelf 20 is expandable like the remainder of the spice rack 10 so that the rack 10 may be used when the spice rack 10 is fully extended or only partially extended.

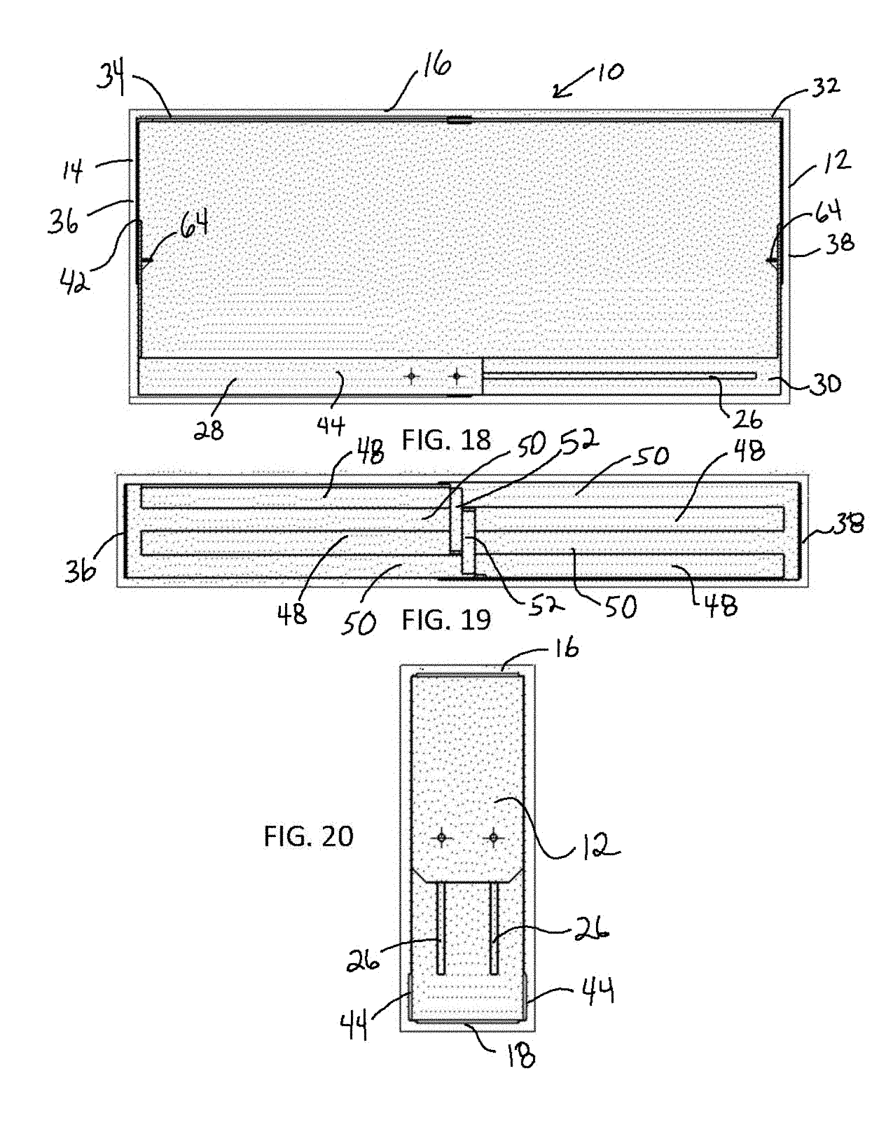

FIGS. 18-20 depict the spice rack 10 in a fully expanded position. The left 28, 34 and right parts 30, 32 may have stops 52 that prevent the parts from completely separating from one another. In addition, the upper and lower parts 28, 30 may have stops that prevent the parts from completely separating.

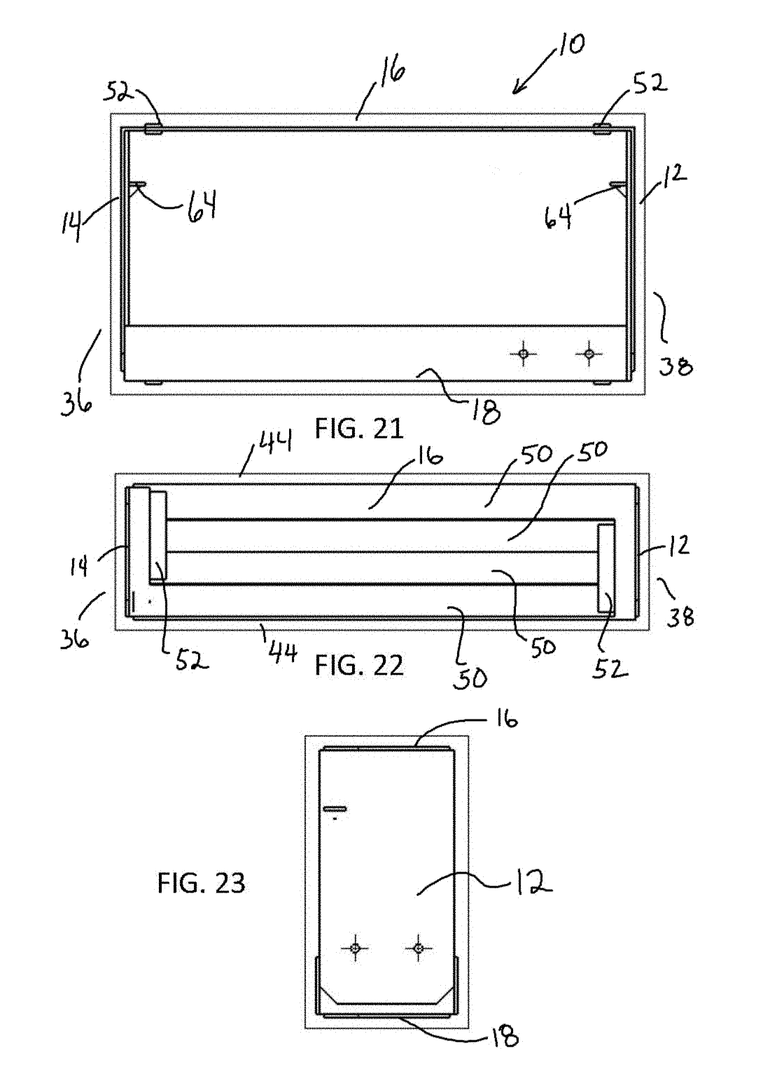

FIGS. 21-23 depict the spice rack 10 in a non-extended position.

Slots 26 are shown, as discussed above, for accepting pins 24. However, recesses could be used instead of slots 26. The various parts may include stops that prevent the parts from extending too far into the interior of an adjacent part. Any type of stops may be used, as known by those of skill in the art. Other types of joining mechanisms may alternatively be used, other than slots 26/pins 24 for permitting the parts to be coupled but movable relative to one another, as will be evident to those of skill in the art.

While the examples described herein teach components that are extendable into four different shapes, it should be recognized that the device 10 can be expandable in fewer directions or greater directions. For example, the examples described expand to the side for one embodiment and upwardly for another embodiment. In alternative embodiments, the device 10 may be expandable only in one direction, such as to the side, or upwardly. Alternative embodiments permit the device 10 to expand forwardly in addition to the side and upwardly by adjusting the configuration of the upper and lower parts 28, 30 to have a portion that extends forward.

The device 10 may be made of polypropylene or other known hard plastic materials. Alternatively, the device 10 could be made of metal or wood. The device 10 is easily cleanable and may be made of either an opaque or clear material. The various parts of the device 10 could be made of a colored material of all one color, or the various parts could be made of differently colored material.

In a first embodiment, a storage shelving system having a width and a height includes a left lower part, a right lower part, a left upper part, and right upper part. The left lower part is telescopically positioned relative to the right lower part to slide within the left lower part. The left upper part is telescopically positioned relative to the right upper part to slide within the right upper part. The left lower part and left upper part are fixably coupled together such that the left lower part vertically aligns with the left upper part. The right lower part and right upper part are fixably coupled together such that the right lower part vertically aligns with the right upper part. The left lower part and left upper part are movable in concert towards and away from the right lower part and right upper part to increase the width of the shelving system or decrease the width of the shelving system.

The shelving system may include a left upper part that is movable vertically towards and away from the left lower part, and a right upper part that is movable vertically towards and away from the right lower part, and the right and left upper parts are movable in concert towards and away from the right and left lower parts to increase the height of the shelving system or decrease the height of the shelving system. The left and right upper parts together may form an upper shelf for holding products and the left and right lower parts together form a lower shelf for holding products.

The left and right upper parts may each include beams that extend towards the opposite part and that together form a substantially solid surface when the left and right upper parts are in a smallest width position. The left and right upper parts may be in a position that has a width that is greater than the smallest width position, with recesses being present between the beams. The left and right lower parts may each include beams that extend towards the opposite part and that together form a substantially solid surface when the left and right lower parts are in the smallest width position. The left and right lower parts may be in a position that has a width that is greater than the smallest width position, with recesses being present between the beams.

The upper left and lower left parts may be coupled by a slidable coupling mechanism. The upper right and lower right parts may be coupled by a slidable coupling mechanism. The upper left and upper right parts may be coupled by a slidable coupling mechanism. The lower left and upper right parts may be coupled by a slidable coupling mechanism. The slidable coupling mechanism may include at least one slot and at least one pin.

The shelving system may also include a removable shelf configured for positioning between the upper left and right parts and the lower left and right parts. The shelving system may also include a support for holding the removable shelf.

The left upper part may be movable vertically towards and away from the left lower part. The right upper part may be movable vertically towards and away from the right lower part. The right and left upper parts may be movable in concert towards and away from the right and left lower parts to increase the height of the shelving system or decrease the height of the shelving system.

The left upper part and left lower part may together define a left side wall. The right upper part and right lower part may together define a right side wall. The left upper part and right upper part may together define an upper surface for holding products. The left lower part and the right lower part may together define a lower surface for holding products.

In another embodiment, a storage shelving system having a height and a width including a left side wall, a right-side wall, a lower wall for holding products, and an upper wall for holding products. The left side wall and right-side wall are coupled together via a coupling mechanism associated with the upper wall at an upper end and via a coupling mechanism associated with the lower wall at a lower end thereof. The coupling mechanism permits the left side wall to slide inwardly and outwardly relative to the right-side wall to adjust the width of the shelving system. The left side wall is adjustable to adjust the height of the shelving system and the right-side wall is adjustable to adjust the height of the shelving system. The left side wall includes a coupling mechanism that permits the left side wall to be extended in height or lowered in height. The right-side wall includes a coupling mechanism that permits the right-side wall to be extended in height or lowered in height.

The coupling mechanism may include a pin and slot slider mechanism.

The shelving system may include a first height where the upper wall is at a maximum height relative to the lower wall, and a second height where the upper wall is at a minimum height relative to the lower wall. The shelving system may include a first width where the left side wall is at a maximum width relative to the right-side wall, and a second width where the left side wall is at a minimum width relative to the right-side wall.

The shelving system may also include a removable inner shelf positioned between the upper wall and the lower wall for holding products. The shelving system may also include shelving supports positioned on the left and right-side walls for supporting the removable inner shelf.

A rim may be positioned around the lower wall. A rim positioned may be positioned around the upper wall. The upper wall may include a plurality of spaced apart beams. The lower wall may also include a plurality of spaced apart beams. The beams may telescope relative to one another to permit the width of the shelving system to be adjusted.

While the above examples are discussed in the context of a spice rack 10, other types of storage racks could benefit from the teachings described herein. For example, the device 10 could be made much larger than that shown herein.

The term “substantially,” as used herein, is a term of estimation.

While various features of the claimed invention are presented above, the features may be used singly or in any combination thereof. Therefore, the claimed invention is not to be limited to only the specific embodiments depicted herein.

Further, variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A storage shelving system having a width and a height comprising:
a left lower part;
a right lower part, with the left lower part being telescopically positioned relative to the right lower part to slide within the left lower part;
a left upper part; and
a right upper part, with the left upper part being telescopically positioned relative to the right upper part to slide within the right upper part,
wherein the left lower part and left upper part are fixably coupled together such that the left lower part vertically aligns with the left upper part, and the right lower part and right upper part are fixably coupled together such that the right lower part vertically aligns with the right upper part, and
wherein the left lower part and left upper part are movable in concert towards and away from the right lower part and right upper part to increase the width of the shelving system or decrease the width of the shelving system.

2. The shelving system of claim 1, wherein the left upper part is movable vertically towards and away from the left lower part, and the right upper part is movable vertically towards and away from the right lower part, and the right and left upper parts are movable in concert towards and away from the right and left lower parts to increase the height of the shelving system or decrease the height of the shelving system.

3. The shelving system of claim 1, wherein the left and right upper parts together form an upper shelf for holding products and the left and right lower parts together form a lower shelf for holding products.

4. The shelving system of claim 3, wherein the left and right upper parts each include beams that extend towards the opposite part and that together form a substantially solid surface when the left and right upper parts are in a smallest width position, and when the left and right upper parts are in a position that has a width that is greater than the smallest width position, recesses are present between the beams; and
wherein the left and right lower parts each include beams that extend towards the opposite part and that together form a substantially solid surface when the left and right lower parts are in the smallest width position, and when the left and right lower parts are in a position that has a width that is greater than the smallest width position, recesses are present between the beams.

5. The shelving system of claim 2, wherein the upper left and lower left parts are coupled by a slidable coupling mechanism; the upper right and lower right parts are coupled by a slidable coupling mechanism; the upper left and upper right parts are coupled by a slidable coupling mechanism; and the lower left and upper right parts are coupled by a slidable coupling mechanism.

6. The shelving system of claim 5, wherein the slidable coupling mechanism comprising at least one slot and at least one pin.

7. The shelving system of claim 1, further comprising a removable shelf configured for positioning between the upper left and right parts and the lower left and right parts.

8. The shelving system of claim 7, further comprising a support for holding the removable shelf.

9. The shelving system of claim 1, wherein the left upper part is movable vertically towards and away from the left lower part, and the right upper part is movable vertically towards and away from the right lower part, and the right and left upper parts are movable in concert towards and away from the right and left lower parts to increase the height of the shelving system or decrease the height of the shelving system.

10. The shelving system of claim 1, wherein the left upper part and left lower part together define a left side wall, the right upper part and right lower part together define a right side wall, the left upper part and right upper part together define an upper surface for holding products, and the left lower part and the right lower part together define a lower surface for holding products.

11. A storage shelving system having a height and a width comprising:
a left side wall;
a right-side wall;
a lower wall for holding products; and
an upper wall for holding products,
wherein the left side wall and right-side wall are coupled together via a coupling mechanism associated with the upper wall at an upper end and via a coupling mechanism associated with the lower wall at a lower end thereof,
wherein the coupling mechanism permits the left side wall to slide inwardly and outwardly relative to the right-side wall to adjust the width of the shelving system;
wherein the left side wall is adjustable to adjust the height of the shelving system and the right-side wall is adjustable to adjust the height of the shelving system, with the left side wall including a coupling mechanism that permits the left side wall to be extended in height or lowered in height, and with the right side wall including a coupling mechanism that permits the right side wall to be extended in height or lowered in height.

12. The shelving system of claim 11, wherein the coupling mechanism comprises a pin and slot slider mechanism.

13. The shelving system of claim 11, wherein the shelving system includes a first height where the upper wall is at a maximum height relative to the lower wall, and a second height where the upper wall is at a minimum height relative to the lower wall; and
a first width where the left side wall is at a maximum width relative to the right-side wall, and a second width where the left side wall is at a minimum width relative to the right-side wall.

14. The shelving system of claim 11, further comprising a removable inner shelf positioned between the upper wall and the lower wall for holding products.

15. The shelving system of claim 14, further comprising shelving supports positioned on the left and right-side walls for supporting the removable inner shelf.

16. The shelving system of claim 11, further comprising a rim positioned around the lower wall.

17. The shelving system of claim 11, further comprising a rim positioned around the upper wall.

18. The shelving system of claim 11, wherein the upper wall comprises a plurality of spaced apart beams and the lower wall comprises a plurality of spaced apart beams, with the beams being telescopically positioned relative to one another to permit the width of the shelving system to be adjusted.
